(19) United States
(12) Patent Application Publication
(10) Pub. No.: US 2003/0179186 A1
(43) Pub. Date: Sep. 25, 2003

(54) Electronic note pad

(76) Inventors: Wen-Tsung Sun, Chiayii Hsien (TW); Chih-Kung Liu, Taotuan Hsien (TW); Shih-Chia Yu, Taipei (TW); Kuan Cheng Huang, Taoyuan (TW)

Correspondence Address: J.C. Patents, Inc., Suite 250, 4 Venture, Irvine, CA, 92618, US

(21) Appl. No.: 10/104,906

(22) Filed: Mar. 22, 2002

(51) Int. Cl. G09G 5/00

(52) U.S. Cl. 345/173

(57) ABSTRACT

An electronic note pad, having a liquid crystal display panel, a touch panel, a computer host, an application software package and a wrist slider. The user can input data at any position of the touch-panel, and the input data is directly stored in a storage apparatus in the computer host. The dimension, that is, length by width, of the liquid crystal display panel ranges from about 100 mm×140 mm to about 190 mm×260 mm. Therefore, the liquid crystal display panel is much larger than that in a personal data assistant (PDA). The larger panel allows the user to input data easily, so that the data input inconvenience of the personal data assistant is thus improved.

### SCENARIO OF THE INVENTION

1. Field of the Invention

The present invention relates in general to an electronic note pad, and more particularly, to an electronic note pad of which a liquid crystal display panel has a dimension ranged between about 100 mm×140 mm and about 190 mm×260 mm.

2. Description of the Related Art

Currently, electronic note pads have not yet been seen in the market. Thus far, the personal digital assistant (PDA) is the only product that provides similar functions. However, as the liquid crystal display (LCD) panel of the personal digital assistant is very small, the personal digital assistant cannot be used as a note pad for inputting or writing data. For example, during a class or a meeting, users such as students, secretaries, and staff can hardly use a personal digital assistant for writing data or making notes.

### SUMMARY OF THE INVENTION

The invention provides an electronic note pad. The user can write or input data on any position on a touch panel, and the written data, including a character thereof, can be stored in an apparatus in a computer host of the electronic note pad. The electronic note pad has a dimension of 100 mm×140 mm to 190 mm×260 mm, so that the user can easily write data therein. The inconvenience in data writing for the personal data assistant is thus resolved.

The invention provides an electronic note pad, on which data can be written or input directly. The electronic note pad comprises a liquid crystal display panel, a touch panel, a computer host, an application software package, and a wrist slider. The liquid crystal display panel uses liquid crystal to display data. The dimension, that is, the length by width, of the liquid crystal display panel is between about 100 mm×140 mm and about 190 mm×260 mm. The touch panel is connected to the liquid crystal display panel, and the available functions displayed thereon can be selected by touch control. Further, data can be written or input on the touch panel directly. The computer host is connected to the liquid crystal display panel and comprises a microprocessor for processing data and a storage apparatus connected to the microprocessor for storing data. The application software package is stored in the computer host to identify and store the data. The wrist slider connected to the touch panel can slide up and down to avoid the user mistakenly touching the touch panel, so as to result in an error of the data recognized by the application software package.

In one embodiment of the invention, the data can be stored in the storage apparatus in a form of a written character. The application software package identifies the data from the top of the touch panel to the bottom of the touch panel. The color of the data can be changed to elicit the identification thereof.

In one embodiment of the invention, a graph can be made on the electronic note pad and stored in the storage apparatus. The application software package performs the identifying process of the graph from the top of the touch panel to the bottom of the touch panel. The color of the graph can be changed to increase the ease of identification of the graph.

The storage apparatus includes a memory card. The wrist slider can be restored by winding. The application software package is operated under the operating system of the computer host.

In one embodiment of the invention, the computer host further comprises a recording apparatus to execute the recording function.

In one embodiment of the invention, the computer host further comprises an infrared transmission apparatus, such that the data is transmitted using infrared transmission. Further, the data stored in the computer can be downloaded to the electronic note pad.

The electronic note pad can also be used as an electronic dictionary, and a calculator for executing various kinds of conversion.

Accordingly, the user can write or input data at any position on the touch panel. By the application software package, the data can be identified. The character written by the user can be stored in the storage apparatus. As the liquid crystal display panel has a dimension of 100 mm×140 mm to 190 mm×260 mm, which is much larger than that of the personal data assistant, it is easily for the user to write with. Therefore, the electronic note pad provided by the invention is writing friendly and has versatile functions.

Both the foregoing general description and the following detailed description are exemplary and explanatory only and are not restrictive of the invention, as claimed.

### BRIEF DESCRIPTION OF THE DRAWINGS

FIG. 1 shows an embodiment of an electronic note pad according to the invention;

FIG. 2 shows a side view of an electronic note pad according to the invention;

FIG. 3 shows a wrist slider of an electronic note pad according to the invention; and

FIG. 4 shows a functional block diagram of an electronic note pad according to the invention.

### DESCRIPTION OF THE PREFERRED EMBODIMENTS

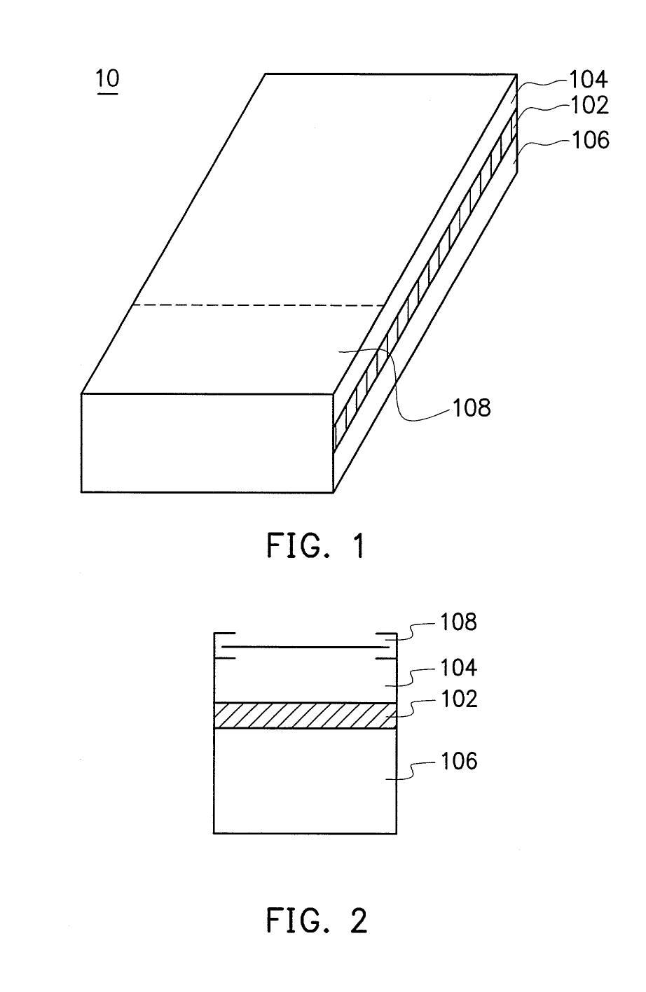

Referring to FIG. 1, an embodiment of an electronic note pad is shown. The user can write data or make a graph directly on the electronic note pad 10. The electronic note pad 10 comprises a liquid crystal display panel 102, a touch panel 104, a computer host 106, and a wrist slider 108. An application software package is stored in the computer host 106. A clear picture of the structure of the electronic note pad 10 can be obtained in FIG. 2. FIG. 2 shows the side views of wrist slide 108, touch panel 104, the liquid crystal display panel 102 and the computer host 106 from top to bottom. The following paragraphs will describe the functions for each of the elements.

The liquid crystal display panel 102 uses liquid crystals to display the manually written data or the drawn graph. The length by width of the liquid crystal display panel 102 is ranged from about 100 mm×140 mm to about 190 mm×260 mm. As this liquid crystal display area is much larger than that of the personal data assistant, it is easier for the user to write data.

The touch panel 104 is connected to the liquid crystal display panel 104. Various function options are displayed on the touch panel 104. By touching any of the function options, the specific function is selected and performed. Further, one can directly write data or draw a picture on the touch panel 104.

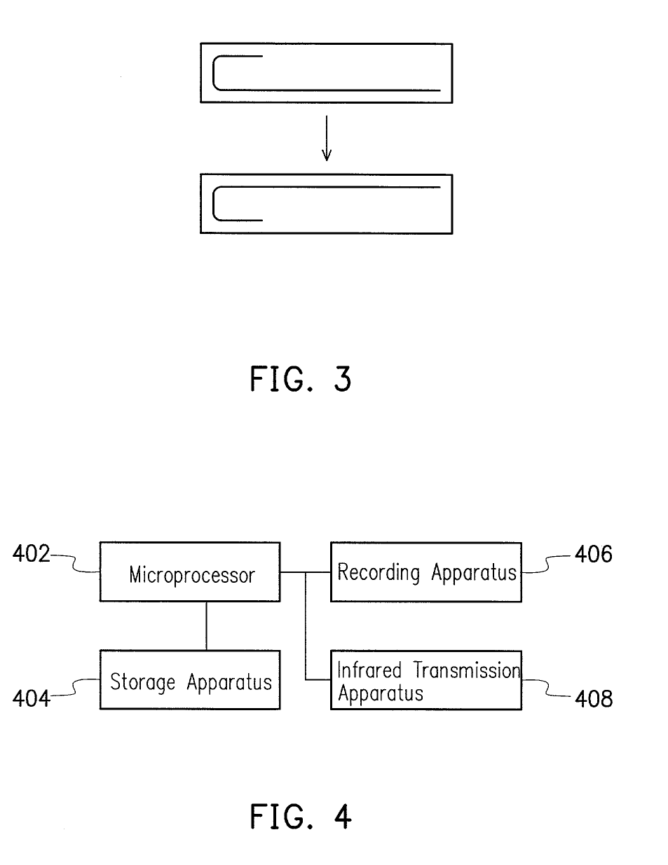

The wrist slider 108 is connected to the touch panel 104. The configuration of the wrist slider 108 is shown in FIG. 3. In FIG. 3, the wrist slider 108 can slide up and down, and be withdrawn or restored by a winding mechanism. The wrist slider 108 prevents the user from mistakenly touching the touch panel 104 during identification by the application software package.

The computer host 106 is connected to the liquid crystal display panel 102. FIG. 4 shows the functional diagram of the computer host 106. The computer host 106 comprises a microprocessor 402, a storage apparatus 404, a voice recording apparatus 406 and an infrared transmission apparatus 408. The microprocessor 402 processes the written or input data and the graph, and controls various functions of the electronic note pad 10. The storage apparatus 404 stores the data and the graph. In this embodiment, the storage apparatus 404 includes a memory card. The full memory card can always be conveniently replaced with a new empty one. The recording apparatus 406 records the voice of the user while inputting or writing data. Thereby, the content of the data is easier to understand. The infrared transmission apparatus 408 allows data transmission by infrared signal between the electronic note pad 10 and any computer.

The application software package is stored in the computer host 106 for data recognition or identification. The data is then stored in the computer host 106 and operated in the operating system thereof. When the user is writing data or making a graph, the data or graph is identified by the application software package and then stored in the memory card of the computer host 106. The data or graph is identified from the top to the bottom of the touch panel 104 by the application software package. Further, the input data stored in the memory card can be stored in the original form, or edited as required.

In addition, when the data or graph is input in the electronic note pad 10, the data or color of the graph can be changed to elicit the identification thereof. The electronic note pad 10 can also be used as an electronic dictionary or a tool for commencing various conversions.

According to the above, the user can write or input data at any position of the touch panel. Further, the data can be identified using the application software package and stored in the storage apparatus of the computer host. The liquid crystal display panel has a length by width of about 100 mm×140 mm to about 190 mm×260 mm. The area is much larger than the display panel in the personal data assistant. It is thus more convenient for the user to write. Thus, the invention provides an electronic note pad which is suitable for handwriting and has versatile functions.

Accordingly, the invention has the following advantages:

1. A larger area of liquid crystal display panel compared to personal data assistant, such that the user can easily write data thereon; and

2. Full functions.

Other embodiments of the invention will appear to those skilled in the art from consideration of the specification and practice of the invention disclosed herein. It is intended that the specification and examples are to be considered as exemplary only, with a true scope and spirit of the invention being indicated by the following claims.

What is claimed is:

1. An electronic note pad, on which a data can be written directly, comprising:
a liquid crystal display panel, with a length by width ranged from about 100 mm×140 mm to about 190 mm×260 mm for displaying the data;
a touch panel connected to the liquid crystal display panel, displaying and providing various function options thereon, wherein the data can be written on the touch panel directly;
a computer host connected to the liquid crystal display, further comprising:
a microprocessor to process the data; and
a storage apparatus connected to the microprocessor, to store the data;
an application software package stored in the computer host, to identify the data and to store the data to the computer host; and
a wrist slider connected to the touch panel to slide up and down, so as to prevent a user from mistakenly touching the touch panel, causing data error during identification performed by the application software package.

2. The electronic note pad according to claim 1, wherein a character of the data can be stored in the storage apparatus.

3. The electronic note pad according to claim 1, wherein the application software package identifies the data from a top of the touch panel to a bottom of the touch panel.

4. The electronic note pad according to claim 1, wherein a color of the data can be changed to elicit the identification thereof.

5. The electronic note pad according to claim 1, wherein a graph can be drawn thereon directly.

6. The electronic note pad according to claim 5, wherein the graph can be stored in the storage apparatus.

7. The electronic note pad according to claim 5, wherein the graph is identified by the application software package from a top of the touch panel to a bottom of the touch panel.

8. The electronic note pad according to claim 5, wherein a color of the graph can be changed to elicit the identification thereof.

9. The electronic note pad according to claim 1, wherein the storage apparatus further comprises a memory card.

10. The electronic note pad according to claim 1, wherein the wrist slider can be restored by winding.

11. The electronic note pad according to claim 1, wherein the application software package is operated under an operating system of the computer host.

12. The electronic note pad according to claim 1, wherein the computer host further comprises a voice recorder to execute voice recording.

13. The electronic note pad according to claim 1, wherein the computer host further comprises an infrared transmission apparatus to allow data transmission between the electronic note pad and a computer performed by an infrared signal.

14. The electronic note pad according to claim 13, wherein the data can be downloaded to the electronic note pad from the host.

15. The electronic note pad according to claim 1, wherein the electronic note pad can be used as an electronic dictionary.

16. The electronic note pad according to claim 1, wherein the electronic note pad can be used for executing various kinds of conversions.
